(19) United States
(12) Patent Application Publication
(10) Pub. No.: US 2015/0169528 A1
(43) Pub. Date: Jun. 18, 2015

(54) Calendar information events

(71) Applicants: Carl Sjogreen, San Francisco, CA (US); Michael Thomas Bolin, Palo Alto, CA (US)

(72) Inventors: Carl Sjogreen, San Francisco, CA (US); Michael Thomas Bolin, Palo Alto, CA (US)

(21) Appl. No.: 11/609,306

(22) Filed: Dec. 11, 2006

Related U.S. Application Data
(60) Provisional application No. 60/825,562, filed on Sep. 13, 2006.

(51) Int. Cl. G06F 17/24; G06Q 10/10

(52) U.S. Cl. CPC G06F 17/245; G06Q 10/1095

(57) ABSTRACT

A calendar system incorporates information from publication sources for display as information events on a calendar of the calendar system. A respective user of the calendar system may subscribe to an identified publication source that is internal or external to the calendar system. The calendar system determines whether data from the identified publication source conforms with a predefined calendar data exchange format. If data from the identified publication source conforms with the predefined calendar data exchange format, the calendar system may import data from the publication source and transmit the data (including data for at least one information event) to at least one client for rendering of the calendar system. If data from the identified publication source fails to conform with the predefined calendar data exchange format, the calendar system may re-format the data to conform to a calendar data exchange format that is compatible with the calendar system.

### CROSS REFERENCE TO RELATED APPLICATIONS

This application claims priority to U.S. Provisional Patent Application Ser. No. 60/825,562, filed Sep. 13, 2006, which is incorporated herein in its entirety by reference.

### TECHNICAL FIELD

The disclosed embodiments relate generally to calendar systems. More particularly, the disclosed embodiments relate to methods, systems, and user interfaces for transmitting and rendering information events from publication sources on a calendar in the calendar system.

### BACKGROUND

Electronic calendars are useful because, typically, they can be viewed and manipulated in a convenient manner from either a user's desktop or portable device. Further, electronic calendars can be shared easily amongst individuals.

However, it is typically inconvenient to incorporate information from various publication sources into a user's selected electronic calendar. For example, recent photographs, blog posts, and news feeds include a date component, but are inconvenient to view through a calendar application.

### BRIEF DESCRIPTION OF THE DRAWINGS

Various embodiments of the invention are disclosed in the following Description of Embodiments herein, in conjunction with the following drawings in which like reference numerals refer to corresponding parts throughout the figures.

FIG. 1 is a block diagram illustrating an exemplary distributed computer system according to certain embodiments of the invention.

FIG. 2 is a block diagram illustrating a calendar system, according to certain embodiments of the invention.

FIG. 3 is a block diagram illustrating a client, according to certain embodiments of the invention.

FIG. 4 is a high-level flowchart representing a method for incorporating information events from publication sources into the calendar system, according to certain embodiments of the invention.

FIG. 5 is a block diagram illustrating a data structure for storing data from publication sources, according to certain embodiments of the invention.

FIG. 6A, 6B, 6C illustrate a schematic of a calendar GUI for displaying information events to the user, according to certain embodiments of the invention.

FIG. 6D is a schematic illustration of a Calendar GUI where information events are represented by icons that hint at the type of information provided by the information events represented by the icons.

### DESCRIPTION OF EMBODIMENTS

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to these particular embodiments. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

According to certain embodiments of the invention, a publication source that provides content that has one or more dates associated with the content is identified and accessed. It is determined whether the data from the publication source conforms with a predefined data exchange format for calendars. If the data conforms with the predefined data exchange format, then the data is transmitted to at least one client where at least a portion of the transmitted data is rendered in a calendar view at a display location corresponding to a date specified for the data. According to some embodiments, if the data fails to conform with a predefined data exchange format, then the data is re-formatted to a default data exchange format for calendars before transmitting the data to at least one client where at least a portion of the transmitted data is rendered in a calendar view at a display location corresponding to a date specified for the data.

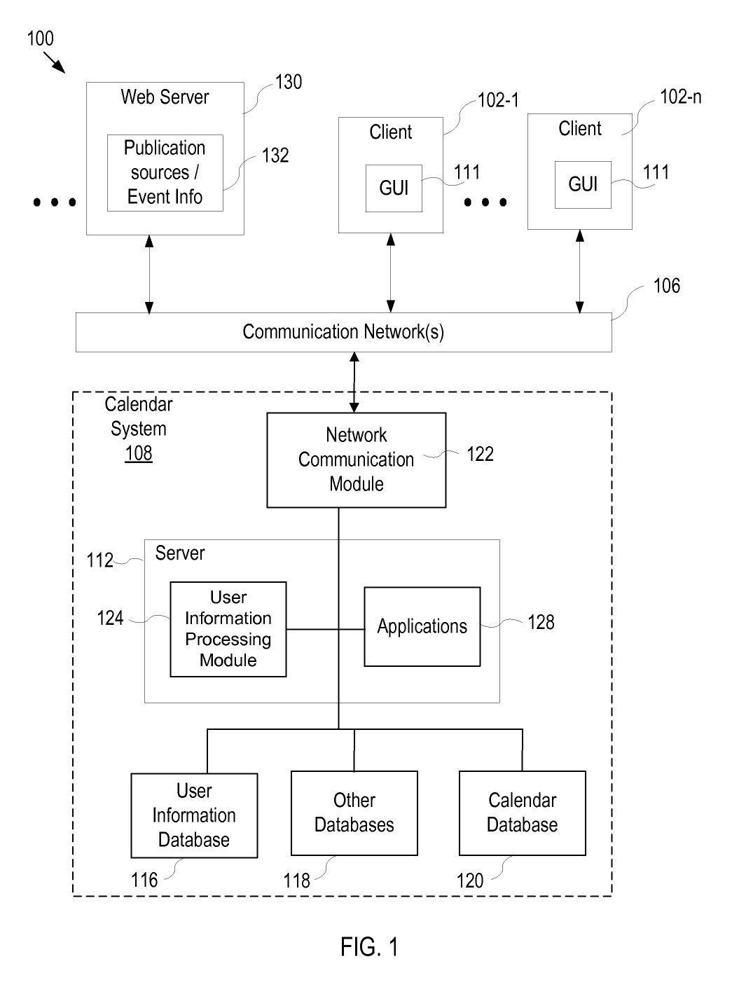

FIG. 1 is a block diagram illustrating an exemplary distributed computer system 100, according to certain embodiments of the invention. In FIG. 1, system 100 may include one or more client computers 102, a communications network 106 a calendar system 108, and one or more web servers (or other computers or devices) 130 that host publication sources 132 of information events. An information event has a specified date, but typically does not have an associated time, includes a link to content associated with information event but which is not included in the information event itself, and typically includes a link to an icon to be displayed in a calendar, at the date specified for the information event, to represent the information event in a space efficient manner in the calendar. In some cases, the icon for an information event is inferred from the source of the information event or, from the content of the information event, or elsewhere, in which case the information event may not include a link to an icon.

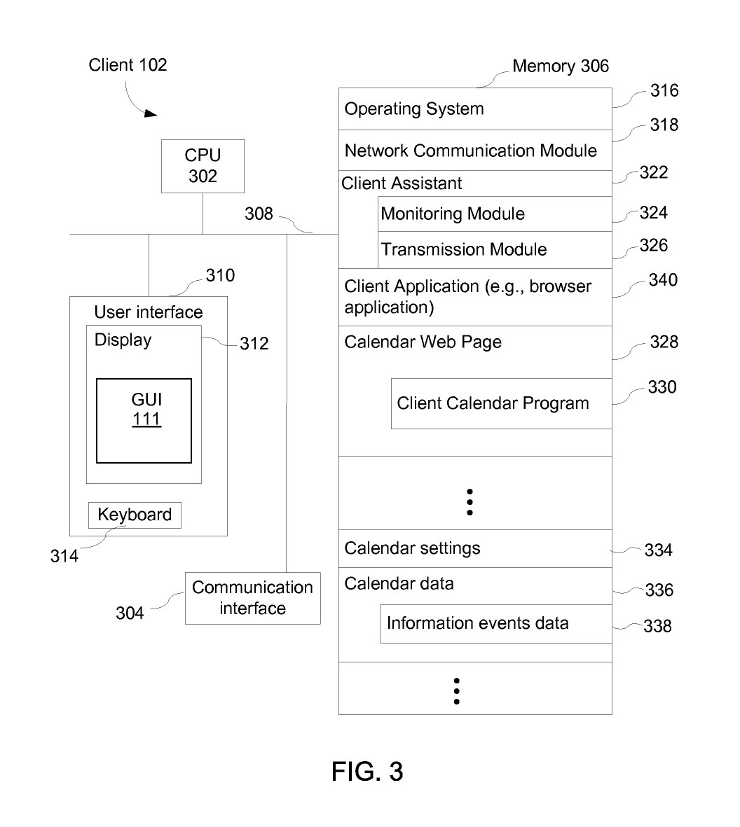

Non-limiting examples of publication sources include electronic news feeds, blog posts, electronic photo galleries, and websites that publish content that has one or more dates associated with the content. Client computers 102 can be any of a number of computing devices (e.g., Internet kiosk, personal digital assistant, cell phone, gaming device, desktop computer, laptop computer, handheld computer, or combinations thereof) used to enable the activities described below. Client computer(s) 102 is also referred to herein as client(s). Client 102 includes a graphical user interface (GUI) 111. One embodiment of client 102 is described in greater detail herein with reference to FIG. 3. Client 102 is connected to calendar system 108 via communications network 106. As described in more detail below, the GUI 111 is used to display a user-selected portion of a calendar. Icons representing information events (as defined below) are rendered, within the user-selected portion of the calendar, at dates associated with the information events.

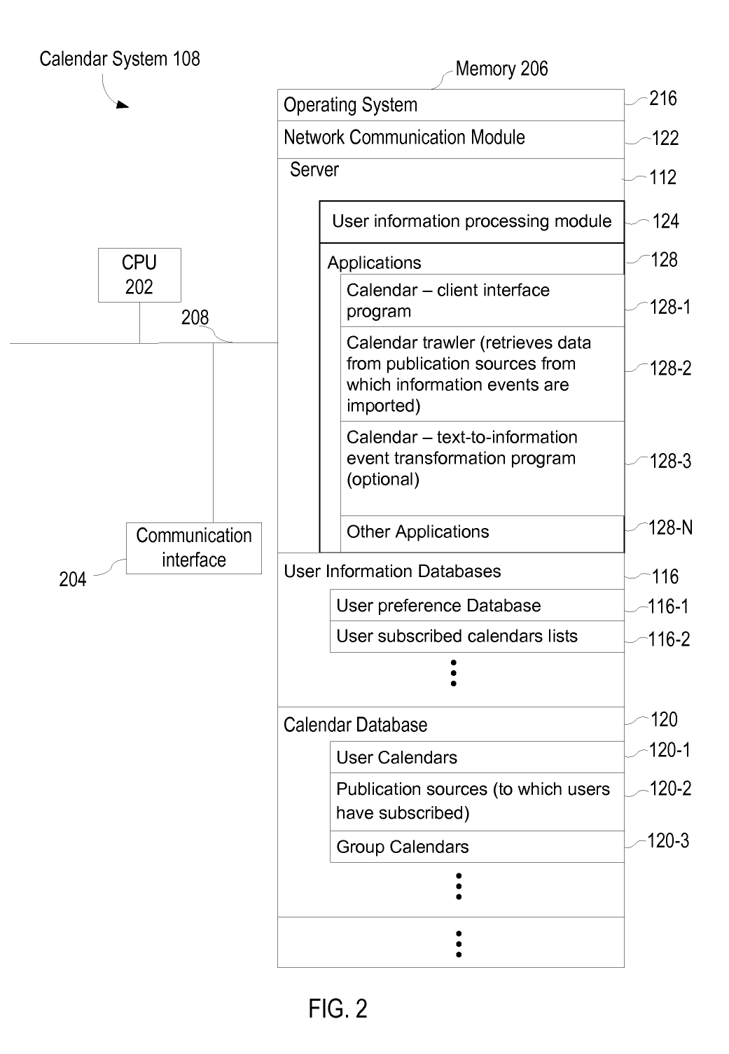

Calendar system 108 includes one or more servers, such as server 112, connected to the communications network 106 via network communication module 122. Calendar system 108 may also include user information databases 116, calendar database 120 and may include other databases 118. Server 112 includes a user information processing module 124 and applications 128. The network communications module 122 connects server 112 to the communication network 106 and enables the receipt of communications from the communication network 106 and the provision of communications to the communication network 106 bound for client 102 or other destinations. Server 112 communicates with databases internal to the calendar system 108, such as user information databases 116, calendar database 120 and other databases 118, if any. These internal communications may be handled by network communication module 122, by a local area network, by internal communication busses, or by any other appropriate mechanism or combination of mechanism. One embodiment of server 112 is described in greater detail herein with reference to FIG. 2.

Server 112 communicates with clients 102 and publication sources 132 via network communication module 122 and communication network(s) 106. Publication sources 132 reside in web servers, or other computers or devices 130 external to the calendar system. Publication sources 132 are typically generated and updated by entities other than the calendar system 108, and thus are typically outside the control of the calendar system 132. Nevertheless, publication sources 132 may contain information events that are of interest to the users of the calendar system 132. When information events are properly formatted (as defined below), the calendar system 108 can import the information events from such publication sources 132 and then provide the information events to those users who have subscribed to one or more of the publication sources.

In the case where the calendar system includes multiple servers, each server, such as server 112, is coupled to a communications network 106 via a network communication module 122. The communications network 106 may be the Internet, but may also be any local area network (LAN), wide area network (WAN), metropolitan area network, or a combination of such networks. In some embodiments, server 112 is a Web server that manages electronic calendars using appropriate communication protocols. Alternatively, if server 112 is used within an intranet, it may be an intranet server.

Applications 128 include application programs used for managing an online calendar system and for retrieving data from publication sources 132. User information processing module 124 assists in accessing, updating and modifying user information databases 116. User information databases 116 store various information associated with the users of the calendar system 108, including user preferences and user calendar subscription lists as described in greater detail herein in reference to FIG. 2. Calendar database 120 may store information (e.g., metadata) concerning various types of calendars as well as data (e.g., calendar data) from various calendars.

In essence, server 112 is configured to manage certain aspects of calendar system 108, including transmitting data to a respective client 102 for rendering at least a portion of the data on an electronic calendar in calendar system 108 based on the respective user's preferences and calendar subscription lists.

In some embodiments, fewer and/or additional modules, functions or databases are included in calendar system 108 and server 112. The modules shown in calendar system 108 and server 112 represent functions performed in certain embodiments.

Notwithstanding the discrete blocks in FIG. 1, the figure is intended to be a functional description of some embodiments of the invention rather than a structural description of functional elements in the embodiments. One of ordinary skill in the art will recognize that an actual implementation might have the functional elements grouped or split among various components. For example, user information databases 116 may be part of server 112. In some embodiments, user information databases 116 may be implemented using one or more servers whose primary function is to store and process user information. Similarly, calendar database 120 may be implemented on one or more servers. The actual number of servers used to implement a calendar system 108 and how features are allocated among them will vary from one implementation to another, and may depend in part on the amount of data traffic that the system must handle during peak usage periods as well as during average usage periods. Moreover, one or more of the blocks in FIG. 1 may be implemented on one or more servers designed to provide the described functionality. Although the description herein refers to certain features implemented in client 102 and certain features implemented in server 112, the embodiments of the invention are not limited to such distinctions. For example, features described herein as being part of server 112 can be implemented in whole or in part in client 102, and vice versa.

FIG. 2 is a block diagram illustrating calendar system 108, according to certain embodiments of the invention. Calendar system 108 includes one or more processing units (CPU's) 202, one or more network or other communications interfaces 204, memory 206, and one or more communication buses 208 for interconnecting these components. The communication buses 208 may include circuitry (sometimes called a chipset) that interconnects and controls communications between system components.

Memory 206 may include high speed random access memory and may also include non-volatile memory, such as one or more magnetic or optical disk storage devices. Memory 206 may optionally include one or more storage devices remotely located from the CPU(s) 202. In some embodiments, memory 206 stores the following programs, modules and data structures, or a subset or superset thereof:
an operating system 216 that includes procedures for handling various basic system services and for performing hardware dependent tasks;
a network communication module (or instructions) 122 that is used for connecting calendar system 108 to other computers (e.g., clients 102 and web servers 130) via one or more communication network interfaces 204 (wired or wireless) and one or more communication networks, such as the Internet, other wide area networks, local area networks, metropolitan area networks, and so on;
a server 112 for managing certain aspects of calendar system 108;
user information databases 116 for storing information that are associated with the users of the calendar system 108, including a user preference database 116-1 and user subscribed calendars lists 116-2; and
a calendar database 120 for storing calendar information, including, for example, a user calendars database 120-1, a publication sources database 120-2 for storing information on publication sources that include information events to which users have subscribed and a group calendars database 120-3; in some embodiments, a single calendar database may be used to store multiple types of calendars, while in other embodiments the calendars may be stored in other configurations.

In some embodiments, server 112 includes the following non-limiting examples of elements, or a subset of such elements: a user information processing module 124, and an applications module 128 that includes application programs such as a calendar client interface application program 128-1, a calendar trawler application program 128-2, and optionally a text-to-information event transformation program 128-3. Applications module 128 may optionally include other applications 128-N. In some embodiments, server 112 uses calendar trawler application program 128-2 to retrieve data from publication sources 132. For example, in some embodiments the calendar trawler 128-2 may periodically (e.g., one or more times per day) access publication sources that provide content that has one or more dates associated with the content and to which users of the calendar system have subscribed, so as to retrieve any new or updated content in those publication sources. The retrieved content, if formatted in a manner compatible with the calendar system, is then incorporated into the calendar database 120. According to certain embodiments, the retrieved content may have a format that is incompatible with the calendar system. In some embodiments, the calendar system includes a text-to-information event transformation program 128-3 that is used to automatically transform the retrieved content into a default format that is compatible with the calendar system. The transformed content is stored in the calendar system and transmitted to calendar users who have subscribed to the publication source from which the content was retrieved. The calendar client interface application program 128-1 sends calendar information to clients 102, and receives and responds to commands received from clients 102. User information processing module 124 may be used for accessing and modifying user information database 116. For example, when a user subscribes to a publication source from which information events can be imported, or the calendar of another user, or un-subscribes from any such publication source or calendar, the user information processing module updates the user information database 116 accordingly. In some embodiments, server 112 and/or the databases 116, and 120 include additional modules.

FIG. 3 is a block diagram illustrating client 102, according to certain embodiments of the invention. Client 102 includes one or more processing units (CPUs) 302, one or more network or other communications interfaces 304, memory 306, and one or more communication buses 308 for interconnecting these components. The communication buses 308 may include circuitry (sometimes called a chipset) that interconnects and controls communications between system components. Client 102 may include a user interface 310, for instance a display 312 with GUI 111 and a keyboard 314. Memory 306 may include high speed random access memory and may also include non-volatile memory, such as one or more magnetic or optical storage disks. Memory 306 may include mass storage that is remotely located from CPUs 302. Memory 306 may store the following elements, or a subset or superset of such elements:
An operating system 316 that includes procedures for handling various basic system services and for performing hardware dependent tasks;
A network communication module (or instructions) 318 that is used for connecting the client 102 to other computers via the one or more communications network interfaces 304 (wired or wireless) and one or more communication networks, such as the Internet, other wide area networks, local area networks, metropolitan area networks, and so on;
A client assistant 322 (e.g., a toolbar, or browser plug-in), which includes a monitoring module 324 for monitoring the activities of a user, and a transmission module 326 for transmitting information about the user's activities (e.g., user commands or activation of calendar features) to and/or receiving information from the calendar system 108;
A client application 340, such as a web browser or other browser application, for displaying web pages and/or other information obtained from one or more online information sources (e.g., web servers);
Calendar web page 328 that includes a client calendar application program 330; in some embodiments the client calendar application program 330 is a program that is executed in a virtual machine environment provided by the client application 340;
Calendar settings 334 for storing the user's calendar settings; and
Calendar data 336 that includes information events data 338.

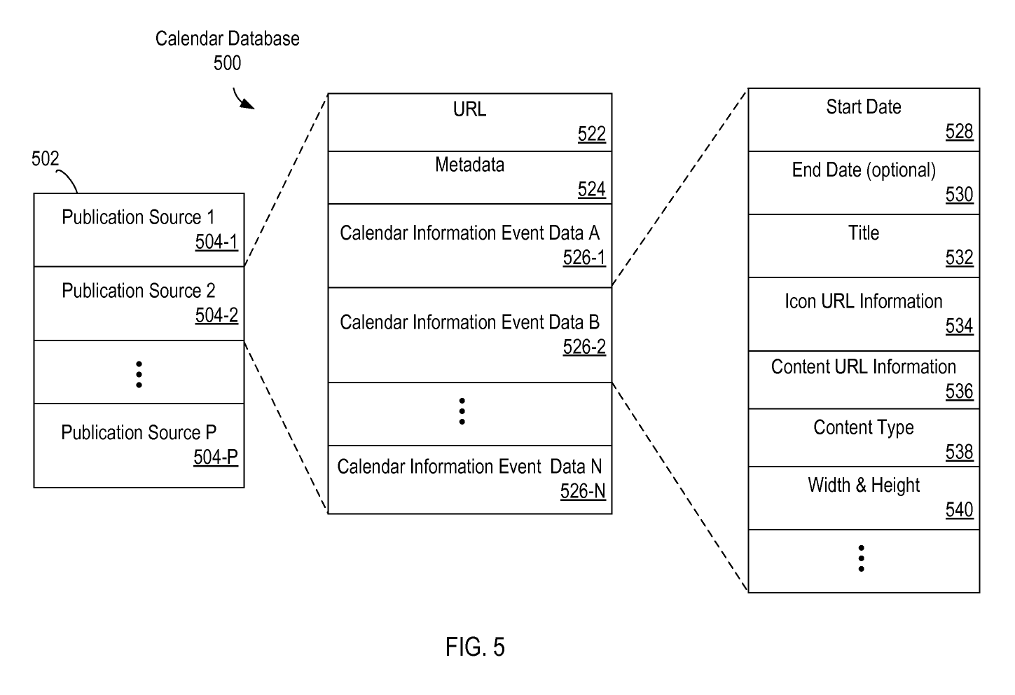

In some embodiments, calendar data 336 includes all the calendar data needed for a current display of calendar information on the GUI 111 of the client 102, as well as additional calendar data for a range of dates before and after the dates currently on view in the GUI 111. The range of dates for which calendar data is stored in the client 102 may vary in accordance with the range of dates that the user (of client 102) has viewed during a current session of working with or viewing the user's online calendar. This calendar data 336 is downloaded by the client calendar program 330, which is executed by the client 102 (e.g., by a browser application residing in the client 102). In some embodiments, the calendar data 336 is organized in a manner similar to the calendar database 500 shown in FIG. 5, which is described below. The calendar program 330 includes instructions for displaying calendar events, portions thereof, or icons corresponding to such events, in the portion of the calendar currently being displayed (e.g., a user-selected portion of the calendar).

The above identified modules and applications in FIG. 2 and FIG. 3 correspond to sets of instructions for performing the functions described above. These modules (i.e., sets of instructions) need not be implemented as separate software programs, procedures or modules, and thus various subsets of these modules may be combined or otherwise re-arranged in various embodiments. In some embodiments, memories 206 and 306 may store a subset of the modules and data structures identified above. Furthermore, memories 206 and 306 may store additional modules and data structures not described above.

Although FIG. 2 and FIG. 3 show calendar system 108 and client 102 as a number of discrete items, FIG. 2 and FIG. 3 are intended more as a functional description of the various features which may be present in calendar system 108 and client 102 rather than as a structural schematic of the embodiments described herein. In practice, and as recognized by those of ordinary skill in the art, items shown separately can be combined and some items can be separated into additional components. For example, some items shown separately in FIG. 2 can be implemented on single servers and single items can be implemented by one or more servers. As another example, some of the databases shown in either of the figures may be combined while other databases may be separated into more granular components. The actual number of servers in calendar system 108 and the manner in which features are allocated among them may vary from implementation to implementation, and may depend in part on the amount of data traffic that the system handles during peak usage periods as well as during average usage periods.

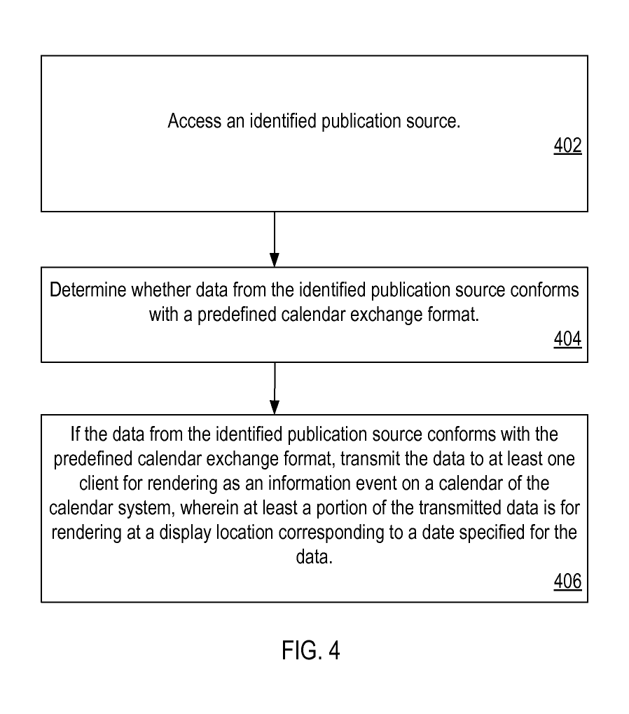

According to certain embodiments, a user can subscribe to a number of publication sources 132 from which information events can be imported. If a publication source subscribed by the user is published in a predefined calendar exchange format, then content from the subscribed publication source can be rendered on the user's electronic calendar as information events as described with reference to FIG. 4 herein.

FIG. 4 is a high-level flowchart representing a method for incorporating information events from publication sources into the calendar system, according to certain embodiments of the invention. It will be appreciated by those of ordinary skill in the art that one or more of the operations described may be performed by hardware, software, or a combination thereof, as may be embodied in one or more computing systems. Further, it will be appreciated by those skilled in the art that some of the acts described with reference to FIG. 4 need not be performed in the order described.

In FIG. 4, an identified publication source is accessed (402). It is determined whether the data from the identified publication source conforms with a predefined calendar exchange format (404). If the data from the identified publication source conforms with a predefined calendar exchange format, the data is transmitted to at least one client for rendering as an information event on a calendar of the calendar system, where at least a portion of the transmitted data is for rendering at a display location corresponding to a date specified for the data (406). In some embodiments, the publication sources include sources that are external to the calendar system as well as sources that are internal to the calendar system.

Non-limiting examples of predefined calendar exchange formats include extensions to content feed formats (e.g., the Atom Syndication format or the RSS format), and extensions to the iCalendar format, according to certain embodiments. In some embodiments, a content feed is specified using a content syndication format, such as RSS. RSS is an acronym that stands for “rich site summary,” “RDF site summary,” or “Really Simple Syndication.” “RSS” may refer to any of a family of formats based on the Extensible Markup Language (XML) for specifying a content feed and content items included in the feed. In some other embodiments, other content syndication formats, such as the Atom syndication format, may be used to specify content feeds.

In some embodiments, the calendar system 108 accepts, from publication sources, content that is formatted in any one of the following distinct calendar data exchange formats: a first calendar data exchange format that is an extension of the iCalendar format (i.e., it includes additional fields for defining information events, as explained in more detail below), a second calendar data exchange format that is based on XML, and a third calendar data exchange format that is based on a predefined content feed format (e.g., Atom or RSS). In other embodiments, the calendar system 108 may accept content in the VCalendar format, extended to include additional fields for defining information events, in addition to or in place of any of the aforementioned data exchange formats. An addition calendar Further, according to certain embodiments, the calendar system will accept information events that are not formatted in any of the above calendar data exchange formats. In such cases, the calendar system automatically re-formats the information event to a default format (e.g., the Atom content feed format for information events) that is compatible with the calendar system. Fields of the resulting information event, such as date, title and summary may be inferred from the received information, while other fields, such as the icon, may be populated with default values.

Table 1 shows an example of the data for an information event, using a calendar exchange format based on the iCalendar format.

TABLE 1

BEGIN:VCALENDAR
BEGIN:VEVENT
DTSTART;VALUE=DATE:20060704
DTEND;VALUE=DATE:20060705
SUMMARY:Independence Day
X-GOOGLE-CALENDAR-CONTENT-TITLE:Independence Day
X-GOOGLE-CALENDAR-CONTENT-
ICON:http://www.google.com/google-favicon.ico
X-GOOGLE-CALENDAR-CONTENT-WIDTH:276
X-GOOGLE-CALENDAR-CONTENT-HEIGHT:120
X-GOOGLE-CALENDAR-CONTENT-
URL:http://www.google.com/logos/july4th06.html
X-GOOGLE-CALENDAR-CONTENT-TYPE:text/html
END:VEVENT

Similarly, Table 2 shows the data for an information event using an XML-based calendar data exchange format. In this example, the XML-based format is also an Atom content feed format.

```
TABLE 2
<entry>
...
<gd:when startTime=“2002-06-15” endTime=“2002-06-16>
</gd:when>
<atom:link rel=“http://schemas.google.com/gCal/2005/webContent”
type=“text/html”
title=“Independence Day”
href=“http://www.google.com/calendar/images/google-holiday.gif”>
<gCal:webContent
  url=“http://www.google.com/logos/july4th06.html”
  width=“276”
  height=“120”/>
</atom:link>
...
</entry>
```

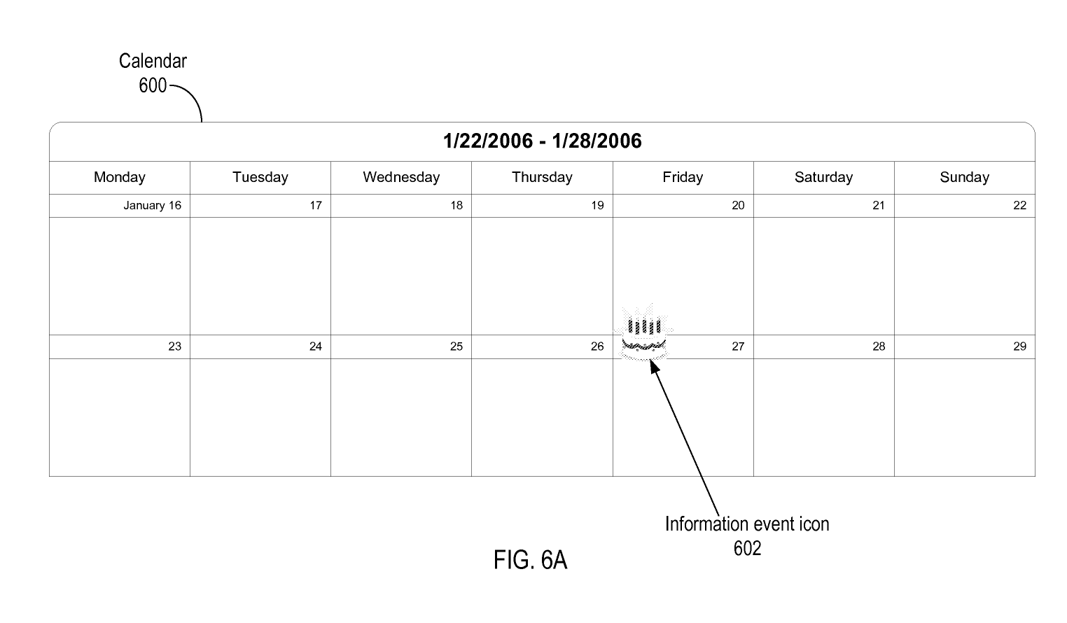

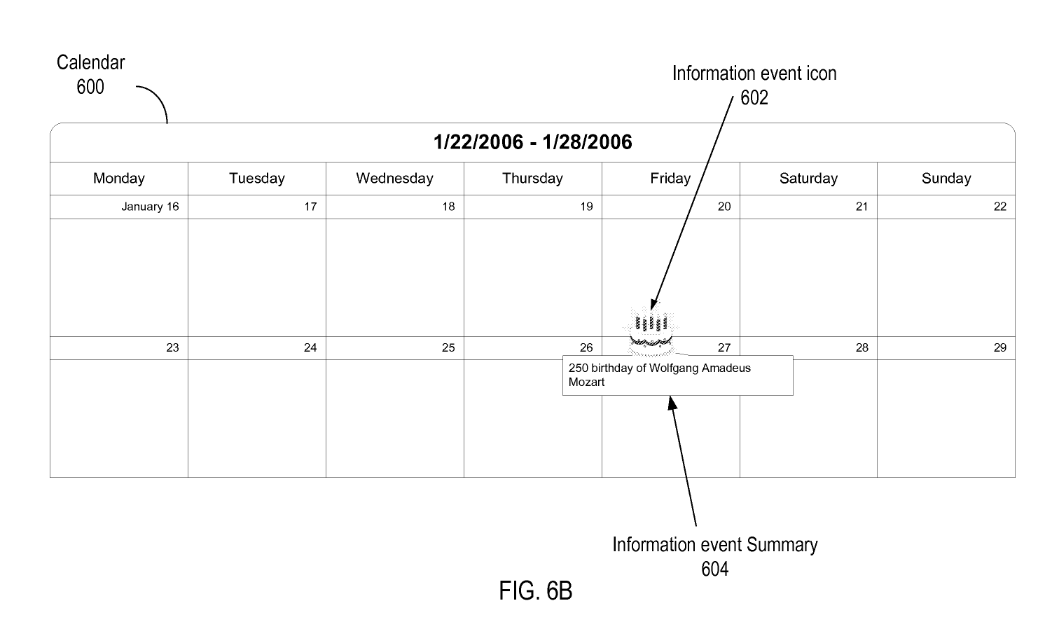

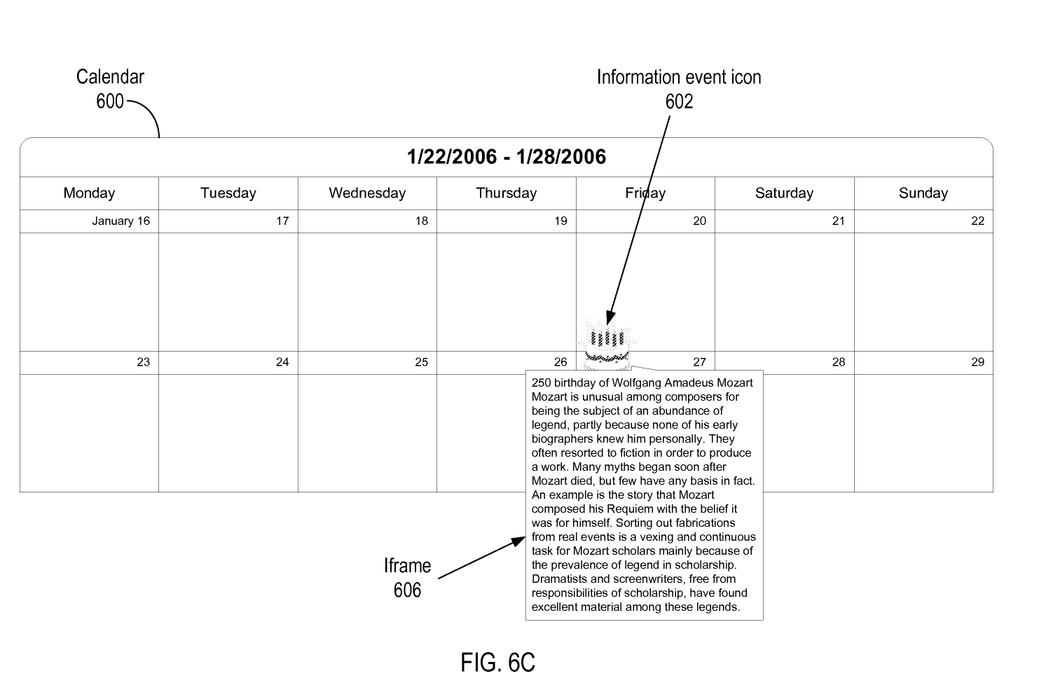

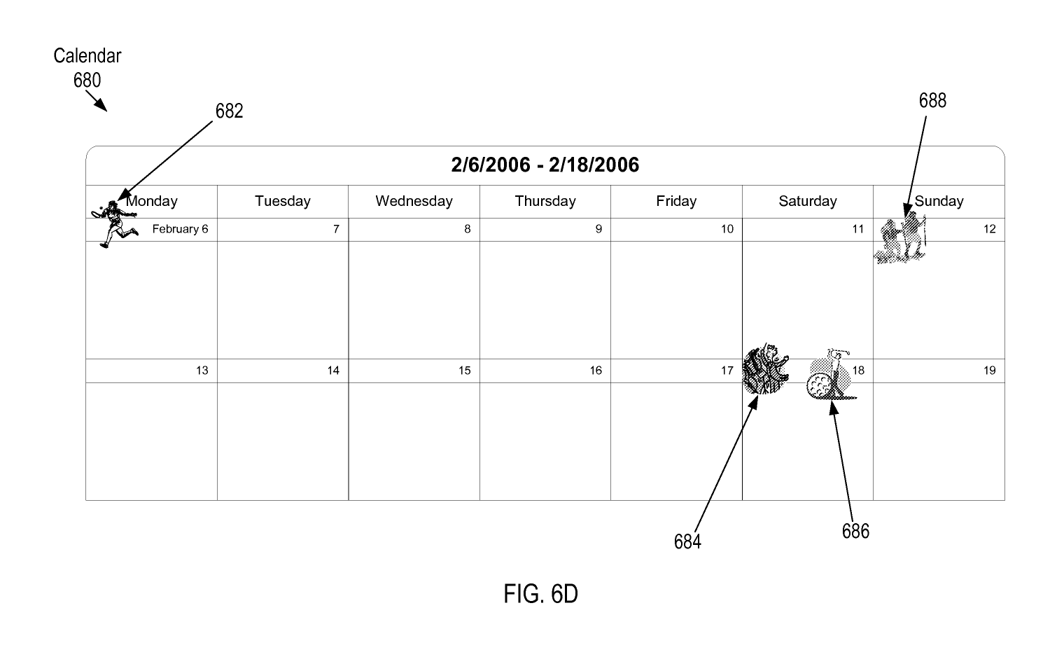

Table 2 shows a “start” and “end” field that specifies a date for the information event. The “title” field specifies a title that may be displayed as an information event summary, as described in greater detail with reference to FIG. 6B herein.

The link rel=http://schemas.google.com/gCal/2005/webContent defines the relation type. The “href” field specifies the icon URL for the information event. The icon URL specifies the location (e.g., an Internet location) of an information event icon to be displayed in a user's calendar. The “gCal: webcontent” field specifies the content URL. The content URL specifies the location (e.g., an Internet location) of content to be displayed when a user selects the information event.

In one embodiment, the first calendar data exchange format is incompatible with the second calendar data exchange format. For example, each publication source provides information events using a distinct calendar data exchange format. According to certain embodiments, an API is exposed for use by content publishers. The API defines fields relating to calendar content, calendar content icon, calendar content title, calendar content URL, calendar content type, calendar content width, and calendar content height, according to certain embodiments.

FIG. 5 is a block diagram illustrating a calendar database for storing data retrieved from publication sources, according to certain embodiments of the invention. FIG. 5 shows a data structure 502 in a calendar database 500. Data structure 502 stores publication sources 504. Publication source 504 includes: URL 522 of the publication source, metadata 524, and calendar information event data 526. Metadata 524 may include information applicable to the entire publication source, such as the title of the publication source, the date of the last update received from the publication source, and so on. Calendar information event data 526 includes data such as start date 528, an optional end date 530, title 532, icon URL information 534 associated with the information event, content URL information 536 associated with the information event, content type 538, width and height 540 of an iframe (inline frame) for displaying content associated with the information event, according to certain embodiments. The icon URL information 534 specifies the location (e.g., an Internet location) of an information event icon to be displayed in a user's calendar. The content URL information 536 specifies the location (e.g., an Internet location) of content to be displayed when a user selects the information event.

The calendar database 500 stored in the calendar system 108 will typically include data for many publication sources. A smaller version of the calendar database 500 (corresponding to information events data 338, FIG. 3) may be stored in a client 102, storing a subset of the information events in the publication source or sources to which a user of the client 102 has subscribed.

FIG. 6A, 6B, 6C are schematic illustrations of a calendar GUI for displaying information events to the user, according to certain embodiments of the invention. Assume for purposes of explanation that User A has an electronic calendar in calendar system B. User A subscribes to a publication source of historical events. Further assume that the publication source of historical events is published in a calendar data exchange format that conforms with a predefined calendar data exchange format specified by calendar system B. FIG. 6A shows User A's electronic calendar 600 with information events from the publication source of historical events displayed as an icon 620 on the date specified for the information event. In some embodiments, the date at which the information event icon 602 is shown is specified by the start date 528 of a calendar information event 526 in the calendar database 500, and the icon 602 itself is retrieved from the Internet location specified by the icon URL information 534 of the same calendar information event 526 in the calendar database 500.

FIG. 6B shows information event summary 604. In some embodiments, for example, information event summary 604 is displayed in response to a user action such as using the computer mouse to hover over information event icon 602. In some embodiments, the information shown in the information event summary 604 corresponds to the title 532 of a same calendar information event 526 in the calendar database 500 (FIG. 5). FIG. 6C shows an iframe 606 (or inline frame) that displays the content of an information event. For example, the content of the information event is displayed in response to a user action such as clicking on information event icon 602. In some embodiments, the information shown in the iframe 606 is found at the Internet location specified by the content URL 536 of a calendar information event 526 in the calendar database 500 (FIG. 5). Furthermore, the width and height of the iframe 606 are specified by the width and height parameters 540 of the calendar information event 526 in the calendar database 500. In this example, the information for the information event icon 602, the information event summary 604 and the information content iframe 606 are all derived from the same information event data 526 in the calendar database 500.

As shown in FIG. 6C, the iframe 606 does not replace the calendar view window 600 (which may be a browser window); rather, when the iframe 606 is invoked by a user action on an information event icon, the iframe 606 is displayed so as to overlap a portion of the calendar view window 600. The user can return to the calendar view window 600 (without it being partially obscured by the iframe 606) by performing a predefined gesture, such as clicking on the calendar view window 600 or by closing the iframe 606.

As shown above, an information event is initially represented in a user's calendar by an icon. The icon may contain a graphic or picture that specifies or hints at the type of information provided by the information event. The displayed icon will typically occupy much less display space than either the summary or the content of the information event. As a result, many information events can be displayed on a calendar, including a plurality of information events on individual dates, without overrunning the display space allocated for those individual dates. FIG. 6D is a schematic illustration of a Calendar GUI where information events are represented by icons that hint at the type of information provided by the information event. For purposes of explanation assume that User A subscribes to a publication source of recreational events. Further assume that the publication source of recreational events is published in a calendar data exchange format that conforms with a predefined calendar exchange format specified by calendar system B. In FIG. 6D, icon 682 hints at a tennis game, icon 684 hints at a music concert, icon 686 hints at a golf game and icon 688 hints at a hiking excursion. The icons shown in FIG. 6D are non-limiting illustrative examples of pictures or graphics that convey information associated with the information events that the icons represent. The image associated with a respective icon can change whenever the image at the URL specified for the icon changes. For example, a publication source may store an image at the specified URL that provides information about an event (e.g., a sporting event) or place or object or the like. For example, the icon for a sporting event may be changed, over a period of time, from a before-event image to any of several in-progress images and then to an after-event image or outcome-representative image. When a user views a calendar that includes the icon for this information event, the user will see the current version of the icon at the URL specified for the information event.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer-implemented method for a calendar system, the method comprising:
at the calendar system, the calendar system having one or more processors and memory storing one or more programs executed by the one or more processors to perform the method:
accessing a publication source external to the calendar system to import calendar data that corresponds to a scheduled first information event, wherein the calendar data includes a scheduled date for the first information event;
transmitting calendar data for the first information event to a client, the calendar data comprising a link to content from the publication source, wherein the content is associated with the first information event;
formatting a first version of a first image representing the first information event for display in a calendar that includes a grid of dates, in accordance with the content; and
formatting a second version of the first image, wherein the second version is different from the first version and replaces the first version.

2. The computer-implemented method of claim 1, further comprising:
determining whether the calendar data imported from the publication source conforms with a predefined calendar data exchange format; and
re-formatting the calendar data to a default format when the calendar data from the publication source fails to conform with the predefined calendar data exchange format.

3-4. (canceled)

5. The computer-implemented method of claim 1, wherein the first version of the first image is displayed at a location within the calendar corresponding to the scheduled date, the method further comprising:
formatting for display, at the location, a second image representing a second information event distinct from the first information event.

6. The computer-implemented method of claim 1, further comprising:
periodically retrieving and transmitting to the client updated calendar data corresponding to the first information event.

7. The computer-implemented method of claim 1, further comprising storing a list of identified publication sources external to the calendar system subscribed to by a user of the calendar system.

8. The computer-implemented method of claim 1, further comprising exposing an API that includes information on the predefined calendar data exchange format for use by publication sources that are external to the calendar system.

9-27. (canceled)

28. The computer-implemented method of claim 1, wherein the transmitted calendar data includes content width and content height data for displaying the content in an iframe.

29. The computer-implemented method of claim 1, wherein the link to content is a URL that specifies an internet location of the content from the publication source.

30. A calendar system, comprising:
one or more processors;
memory storing one or more programs to be executed by the one or more processors, the one or more programs including instructions for:
accessing a publication source external to the calendar system to import calendar data that corresponds to a scheduled first information event, wherein the calendar data includes a scheduled date for the first information event;
transmitting calendar data for the first information event to a client, the calendar data comprising a link to content from the publication source, wherein the content is associated with the first information event;
formatting a first version of a first image representing the first information event for display in a calendar that includes a grid of dates, in accordance with the content; and
formatting a second version of the first image, wherein the second version is different from the first version and replaces the first version.

31. The calendar system of claim 30, wherein the first version of the first image is displayed at a location within the calendar corresponding to the scheduled date and wherein the one or more programs further comprise instructions for:
formatting for display, at the location, a second image representing a second information event distinct from the first information event.

32. The calendar system of claim 30, wherein the one or more programs further comprise instructions for:
periodically retrieving and transmitting to the client updated calendar data corresponding to the first information event.

33-34. (canceled)

35. A non-transitory computer readable storage medium storing one or more programs which, when executed by one or more processors of a calendar system, cause the calendar system to:
access a publication source external to the calendar system to import calendar data that corresponds to a scheduled first information event, wherein the calendar data includes a scheduled date for the first information event;
transmit calendar data for the first information event to a client, the calendar data comprising a link to content from the publication source, wherein the content is associated with the first information event;
format a first version of a first image representing the first information event for display in a calendar that includes a grid of dates, in accordance with the content; and
formatting a second version of the first image, wherein the second version is different from the first version and replaces the first version.

36. The non-transitory computer readable storage medium of claim 35, wherein the first version of the first image is displayed at a location within the display calendar corresponding to the scheduled date and wherein the one or more programs further comprise instructions for:
formatting for display, at the location, a second image representing a second information event distinct from the first information event.

37. The non-transitory computer readable storage medium of claim 35, wherein the one or more programs further comprise instructions that cause the calendar system to:
periodically retrieve and transmit to the client updated calendar data corresponding to the first information event.

38-39. (canceled)

40. A method comprising:
at a client system having one or more processors and memory storing one or more programs executed by the one or more processors to perform the method:
subscribing to a publication source external to a calendar system;
receiving calendar data for a scheduled first information event, the calendar data comprising a link to content from the publication source, wherein the content is associated with the first information event;
using the link to retrieve from the publication source a first version of a first image representing the first information event and a scheduled date for the first information event;
displaying, in a calendar that includes a grid of dates, the first version of the first image at a location in the calendar corresponding to the scheduled date;
using the link to retrieve from the publication source a second version of the first image; and
displaying at the location in the calendar the second version of the first image, thereby replacing the first version of the first image.

41. The method of claim 40, further comprising:
formatting for display, at the location, a second image representing a second information event distinct from the first information event.

42. The method of claim 40, further comprising periodically retrieving updated calendar data corresponding to the first information event, and displaying a subsequent version of the first image according to the updated calendar data.

43-44. (canceled)

45. The method of claim 1, wherein the first version of the image is initially displayed without text describing the first information event.

46. (canceled)

47. (canceled)

48. The method of claim 1, wherein the second version of the first image indicates a status change with respect to the first information event.

49. The method of claim 48, wherein the first version of the first image represents a status before the first information event has occurred and the second version of the first image represents a status while the first information event is occurring.

50. The method of claim 49, further comprising formatting a third version of the first image, wherein the third version is different from the second version, replaces the second version, and represents a status after the first information event has occurred.
